(19) United States
(12) Patent Application Publication
(10) Pub. No.: US 2024/0373383 A1
(43) Pub. Date: Nov. 7, 2024

(54) USER EQUIPMENT, BASE STATION, AND WIRELESS COMMUNICATION METHOD

(71) Applicant: PURPLEVINE INNOVATION COMPANY LIMITED, Hong Kong (CN)

(72) Inventor: Chiu-Wen CHEN, Hong Kong (HK)

(73) Assignee: PURPLEVINE INNOVATION COMPANY LIMITED, Hong Kong (CN)

(21) Appl. No.: 18/682,894

(22) PCT Filed: Aug. 11, 2022
(86) PCT No.: PCT/CN2022/111923

§ 371 Date: Feb. 10, 2024

Related U.S. Application Data
(63) Continuation-in-part of application No. PCT/CN2022/111922, filed on Aug. 11, 2022.
(60) Provisional application No. 63/231,733, filed on Aug. 11, 2021.
(60) Provisional application No. 63/231,733, filed on Aug. 11, 2021.

(51) Int. Cl. H04W 56/00; H04W 74/0833; H04W 76/27

(52) U.S. Cl. CPC H04W 56/0045; H04W 74/0833; H04W 76/27

(57) ABSTRACT

A wireless communication method for execution by a user equipment (UE) is provided. The UE receives a radio resource control (RRC) message used for transiting the UE to an RRC inactive state and starts a small data transmission (SDT) time alignment timer (TAT) upon receiving the RRC message. The UE determines whether timing alignment (TA) for the UE is validated through TA validation at least based on the TAT and at least one measurement of reference signal received power (RSRP) compared to at least one RSRP associated threshold. The UE transmits uplink small data on pre-configured SDT resources in the RRC inactive state of the UE when the TA for the UE is validated through TA validation.

### TECHNICAL FIELD

The present disclosure relates to the field of communication systems, and more particularly, to a wireless communication method and related devices for small data transmission (SDT) in radio resource control (RRC) inactive state (i.e., RRC_INACTIVE).

### BACKGROUND ART

Wireless communication systems, such as the third-generation (3G) of mobile telephone standards and technology are well known. Such 3G standards and technology have been developed by the Third Generation Partnership Project (3GPP). The 3rd generation of wireless communications has generally been developed to support macro-cell mobile phone communications. Communication systems and networks have developed towards being a broadband and mobile system. In cellular wireless communication systems, user equipment (UE) is connected by a wireless link to a radio access network (RAN). The RAN comprises a set of base stations (BSs) that provide wireless links to the UEs located in cells covered by the base station, and an interface to a core network (CN) which provides overall network control. As will be appreciated the RAN and CN each conduct respective functions in relation to the overall network. The 3rd Generation Partnership Project has developed the so-called Long Term Evolution (LTE) system, namely, an Evolved Universal Mobile Telecommunication System Territorial Radio Access Network, (E-UTRAN), for a mobile access network where one or more macro-cells are supported by a base station known as an eNodeB or eNB (evolved NodeB). More recently, LTE is evolving further towards the so-called 5G or NR (new radio) systems where one or more cells are supported by a base station known as a gNB.

### TECHNICAL PROBLEM

Small data transmission via 2-step random access channel (RACH), 4-step RACH, configured grant (CG) in RRC_INACTIVE state is supported for NR system.

In RRC_CONNECTED, the UE has a configurable timing alignment (TA) timer which is used to control how long the UE is considered uplink timing aligned with the associated cell. In case of configured grant in RRC_INACTIVE, a timing alignment mechanism should be introduced for small data transmission. Considering UE's mobility and channel quality variation (e.g., time domain and spatial domain), uplink TA validation is an essential issue for subsequent small data transmission in RRC_INACTIVE state.

Hence, a wireless communication method to support cross-FFP scheduling is desired.

### TECHNICAL SOLUTION

An object of the present disclosure is to propose a user equipment, a base station, and a wireless communication method in an unlicensed band.

In a first aspect, an embodiment of the invention provides a wireless communication method executable in a user equipment (UE), comprising:
receiving a radio resource control (RRC) message used for transiting the UE to an RRC inactive state;
starting a small data transmission (SDT) time alignment timer (TAT) upon receiving the RRC message;
determining whether timing alignment (TA) for the UE is validated through TA validation at least based on the TAT and at least one measurement of reference signal received power (RSRP) value compared to at least one RSRP associated threshold; and
transmitting uplink (UL) small data on pre-configured SDT resources in the RRC inactive state of the UE when the TA for the UE is validated through TA validation.

In a second aspect, an embodiment of the invention provides a user equipment (UE) comprising a processor configured to call and run a computer program stored in a memory, to cause a device in which the processor is installed to execute the disclosed method.

In a third aspect, an embodiment of the invention provides a wireless communication method executable in a base station, comprising:
configuring an RSRP associated threshold and pre-configured small data transmission (SDT) resources for uplink SDT in a RRC inactive state;
transmitting one or more radio resource control (RRC) messages that carries an SDT configuration including at least one reference signal received power (RSRP) value associated threshold for an SDT,
wherein the RSRP associated threshold comprises an RSRP difference threshold and a synchronization signal block (SSB) level RSRP threshold; and
receiving the uplink SDT.

In a fourth aspect, an embodiment of the invention provides a base station comprising a processor configured to call and run a computer program stored in a memory, to cause a device in which the processor is installed to execute the disclosed method.

The disclosed method may be programmed as computer executable instructions stored in non-transitory computer-readable medium. The non-transitory computer-readable medium, when loaded to a computer, directs a processor of the computer to execute the disclosed method.

The non-transitory computer-readable medium may comprise at least one from a group consisting of: a hard disk, a CD-ROM, an optical storage device, a magnetic storage device, a Read-Only Memory, a Programmable Read-Only Memory, an Erasable Programmable Read-Only Memory, EPROM, an Electrically Erasable Programmable Read-Only Memory and a Flash memory.

The disclosed method may be programmed as a computer program product that causes a computer to execute the disclosed method.

The disclosed method may be programmed as a computer program, that causes a computer to execute the disclosed method.

### ADVANTAGEOUS EFFECTS

One or more embodiments of the disclosure has been provided to address the above-identified problem and aims to provide a method for time alignment validation in RRC_INACTIVE state. A time alignment validation procedure for small data transmission is proposed in the present disclosure. In accordance with an aspect of the present disclosure, some criterions for the accuracy of time alignment validation are proposed to solve the issues in the prior art. In accordance with another aspect of the present disclosure, at least one dynamic grant for the RRC_INACTIVE UE is used for subsequent small data transmission. The present disclosure may be beneficial in improving radio resource efficiency of the network and power efficiency of the UE.

### DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure. A person having ordinary skills in this field may obtain other figures according to these figures without paying the premise.

FIG. 1 illustrates a schematic view of a telecommunication system.

FIG. 2 illustrates a schematic view showing functional blocks of a user equipment (UE) and a base station.

FIG. 3 illustrates a schematic view showing UE radio resource control (RRC) state transitions in NR.

FIG. 4 illustrates a schematic view showing a wireless communication method according to an embodiment of the invention.

FIG. 5 illustrates a schematic view showing a wireless communication method according to another embodiment of the invention.

FIG. 6 illustrates a schematic view showing an example of a medium access control (MAC) control element (CE) for SDT buffer status reporting (BSR).

FIG. 7 illustrates a schematic view showing another example of a medium access control (MAC) control element (CE) for SDT buffer status reporting (BSR).

FIG. 8 illustrates a schematic view showing an example of a medium access control (MAC) control element (CE) for SDT power headroom reporting (PHR).

FIG. 9 illustrates a schematic view showing another example of a medium access control (MAC) control element (CE) for SDT power headroom reporting (PHR).

FIG. 10 illustrates a schematic view showing still another example of a medium access control (MAC) control element (CE) for SDT power headroom reporting (PHR).

FIG. 11 illustrates a schematic view showing a first embodiment of the wireless communication method and timing with reference to a time alignment timer (TAT) and a waiting window.

FIG. 12 illustrates a schematic view showing a second embodiment of the wireless communication method and timing with reference to a time alignment timer (TAT) and a waiting window.

FIG. 13 illustrates a schematic view showing a third embodiment of the wireless communication method and timing with reference to a time alignment timer (TAT) and a waiting window.

FIG. 14 illustrates a schematic view showing a fourth embodiment of the wireless communication method and timing with reference to a time alignment timer (TAT) and a waiting window.

FIG. 15 illustrates a schematic view showing a fifth embodiment of the wireless communication method and timing with reference to a time alignment timer (TAT) and a waiting window.

FIG. 16 illustrates a schematic view showing a sixth embodiment of the wireless communication method and timing with reference to a time alignment timer (TAT) and a waiting window.

FIG. 17 illustrates a schematic view showing a system for wireless communication according to an embodiment of the present disclosure.

### DETAILED DESCRIPTION OF EMBODIMENTS

Embodiments of the disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

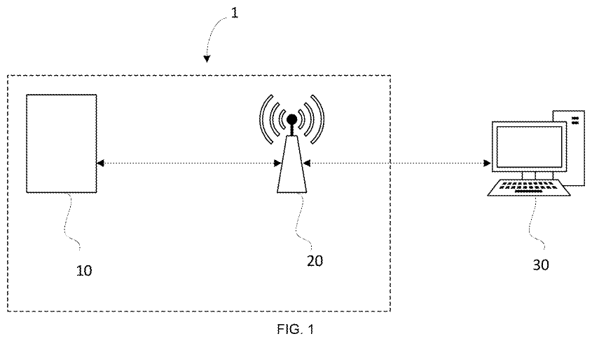

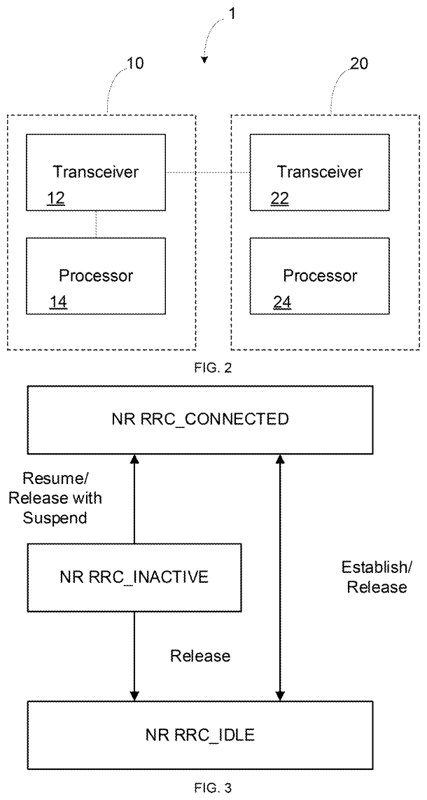

A schematic view and a functional block diagram of a communication controlling system 1 according to the present invention are shown in FIG. 1 and FIG. 2 respectively. The communication controlling system 1 comprises a user equipment 10 and a base station 20. The user equipment 10 and the base station 20 may communicate with each other either wirelessly or in a wired way. The base station 20 and a next generation core network 30 may also communicate with each other either wirelessly or in a wired way. When the communication controlling system 1 complies with the New Radio (NR) standard of the 3rd Generation Partnership Project (3GPP), the next generation core network (5GCN) 30 is a backend serving network system and may comprise an Access and Mobility Management Function (AMF), User Plane Function (UPF), and a Session Management Function (SMF). The user equipment 10 may be a non-NPN capable apparatus or a non-public network (NPN) capable apparatus, but the present disclosure is not limited to this. The user equipment 10 comprises a transceiver 12 and a processor 14, which are electrically connected with each other. The transceiver 12 of the user equipment 10 is configured to transmit a signal to the base station 20 so that the user equipment 10 communicates with the base station 20 each other.

Uplink (UL) transmission of a control signal or data may be a transmission operation from a UE to a base station. Downlink (DL) transmission of a control signal or data may be a transmission operation from a base station to a UE. In the following description, unless elsewhere specified, a UE can be interpreted as an embodiment of the UE 10, and a gNB or a base station can be interpreted as an embodiment of the base station 20.

In this document, the term “/” should be interpreted as “and/or.” The term “network” refers to at least the base station 20. Alternatively, the term “network” may refer to one or more entities (e.g., base stations, central units, distributed units, radio nodes, and relay nodes) in a RAN and/or one or more entities in a CN. In the description, unless elsewhere specified, resource(s) refer to radio resource(s). Unless elsewhere specified, a transmission buffer (TX buffer) is a TX buffer of a UE (e.g., the UE 10). In the description, threshold(s) (e.g., SDT threshold(s), CG-SDT threshold(s), RSRP threshold(s), and/or RSRP threshold(s)) is/are met means one or more criteria associated with the threshold(s) is/are satisfied.

Some recurring terms used in the description are list in the following:

TABLE 1

| Abbreviation | Full name |
|---|---|
| AOA | angle of arrival |
| BSR | buffer status reporting |
| CG | configured grant |
| DG | dynamic grant |
| HARQ | hybrid automatic repeat request |
| LCG | logical channel group |
| MAC | medium access control |
| CE | control element |
| PUSCH | physical uplink shared channel |
| RACH | random access channel |
| RRC | radio resource control |
| RSRP | reference signal received power |
| SDT | small data transmission |
| SSB | synchronization signal block |
| TDOA | time difference of arrival (TDoA) |

FIG. 3 shows an overview of UE RRC state transitions in NR. A UE is either in RRC_CONNECTED state or in RRC_INACTIVE state when an RRC connection has been established. In RRC_INACTIVE state, the network and UE store the UE inactive access stratum (AS) context for small data transmission (SDT) with lower power consumption. For SDT in RRC_INACTIVE state, the UE may receive an RRCRelease with suspend configuration (i.e., suspendConfig, such as for performing SDT or updating SDT configuration) and resumes the RRC connection if necessary. Upon the reception of RRCRelease without suspend configuration (i.e., RRC connection is released), the UE transits to RRC_IDLE state. The suspend configuration represents a field suspendConfig or an information element SuspendConfig in RRCRelease. Definition of the suspend configuration may be referred to in TS 38.331.

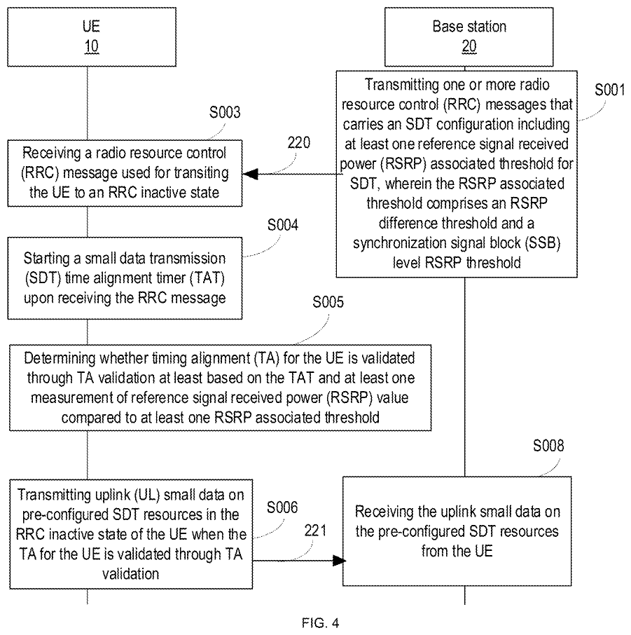

With reference to FIG. 4, a UE, such as the UE 10, and a base station, such as the base station 20, execute a wireless communication method.

The base station configures an RSRP associated threshold and pre-configured small data transmission (SDT) resources for uplink SDT in a UE RRC inactive state and transmits one or more RRC messages that carries a small data transmission (SDT) configuration 220 including at least one reference signal received power (RSRP) associated threshold for SDT (S001). The one or more RRC messages may comprise system information block one (SIB1) and/or an RRCRelease. For example, a RRC message of the one or more RRC messages is used for transiting a user equipment (UE) to an RRC inactive state. In an embodiment, the at least one RSRP associated threshold is included in an SDT configuration provided in system information block one (SIB1). In an embodiment, the at least one RSRP associated threshold is included in an SDT configuration provided in an RRC message of RRCRelease. In an embodiment, the at least one RSRP associated threshold is included in an SDT configuration provided in an RRC message of RRCRelease with SuspendConfig.

The UE receives an RRC message used for transiting the UE to an RRC inactive state (S003). The RRC message received by the UE is one of the one or more RRC messages.

The UE starts a small data transmission (SDT) time alignment timer (TAT) upon receiving the RRC message (S004).

The UE determines whether timing alignment (TA) for the UE is validated through TA validation at least based on the TAT and at least one measurement of reference signal received power (RSRP) compared to at least one RSRP associated threshold (S005).In an embodiment, the at least one measurement of RSRP value comprises:
a first RSRP value that is measured by the UE when the UE receives the SDT configuration; and.
a second RSRP value that is measured by the UE when the UE determines to perform SDT.

In an embodiment, the at least one RSRP associated threshold comprises an RSRP difference threshold. The TA for the UE is validated through TA validation when an RSRP difference between the first RSRP value and the second RSRP value is less than the RSRP difference threshold. The TA for the UE is not valid when the RSRP difference is not less than the RSRP difference threshold. In an embodiment, the RSRP difference threshold that is UE-specific.

In an embodiment, the UE performs dynamic grant small data transmission (DG-SDT) when the RSRP difference is not less than the RSRP difference threshold.

In an embodiment, the UE performs random access small data transmission (RA-SDT) when the RSRP difference is not less than the RSRP difference threshold.

In an embodiment, the UE performs the RA-SDT when the RSRP difference is not less than the RSRP difference threshold while the TAT is running.

The UE transmits uplink (UL) small data 221 on pre-configured SDT resources in the RRC inactive state of the UE when the TA for the UE is validated through TA validation (S006).

The base station receives the uplink small data 221 on the pre-configured SDT resources from the UE in the RRC inactive state (S008). In an embodiment, the transmitting uplink small data on the pre-configured SDT resources is an initial configured grant small data transmission (CG-SDT). The UE starts a timer to time a waiting window after the initial CG-SDT and monitors, during the waiting window, a physical downlink control channel (PDCCH) for a response that responds the initial CG-SDT.

In an embodiment, the at least one RSRP associated threshold comprises a synchronization signal block (SSB) level RSRP threshold; and the UE selects a subset of SSBs for small data transmission based on the SSB level RSRP threshold.

In an embodiment, the SSB level RSRP threshold is UE-specific.

In an embodiment, the SSB level RSRP threshold is configured in RRC signalling for a multi-beam operation.

In an embodiment, the SSB level RSRP threshold is commonly shared by CG-SDT and RA-SDT, and the UE selects at least one of available SSBs for CG-SDT based on the SSB level RSRP threshold.

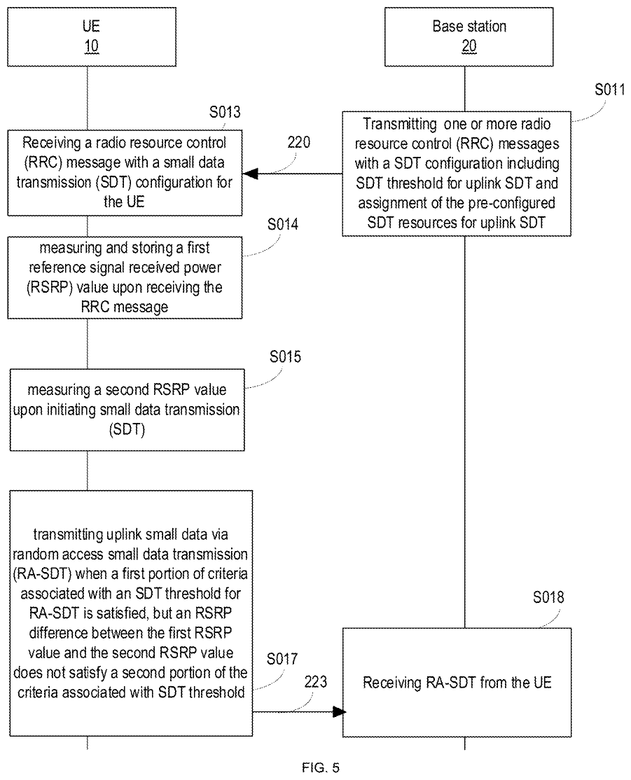

With reference to FIG. 5, a UE, such as the UE 10, and a base station, such as the base station 20, execute a wireless communication method.

The base station configures small data transmission (SDT) threshold and pre-configured SDT resources for uplink SDT and transmits one or more radio resource control (RRC) messages with a small data transmission (SDT) configuration 220 including SDT threshold for uplink SDT and assignment of the pre-configured SDT resources for uplink SDT (S011). The one or more RRC messages may comprise system information block one (SIB1) and/or an RRCRelease. For example, a RRC message of the one or more RRC messages is used for transiting a user equipment (UE) to an RRC inactive state. In an embodiment, the SDT threshold is included in an SDT configuration provided in system information block one (SIB1). In an embodiment, the SDT threshold is included in an SDT configuration provided in an RRC message of RRCRelease. In an embodiment, the SDT threshold is included in an SDT configuration provided in an RRC message of RRCRelease with SuspendConfig.

The UE receives an RRC message with the small data transmission (SDT) configuration 220 for the UE (S013). The RRC message received by the UE is one of the one or more RRC messages.

The UE measures and stores a first reference signal received power (RSRP) upon receiving the RRC message (S014).

The UE measures a second RSRP upon initiating small data transmission (SDT) (S015).

The UE transmits uplink small data 223 via random access small data transmission (RA-SDT) when a first portion of criteria associated with an SDT threshold for RA-SDT is satisfied, but an RSRP difference between the first RSRP and the second RSRP does not satisfy a second portion of the criteria associated with SDT threshold (S017).

The base station receives the RA-SDT carrying the uplink small data 223 when a first portion of criteria associated with the SDT threshold for uplink SDT is satisfied, while a reference signal received power (RSRP) difference between a first RSRP and a second RSRP does not satisfy a second portion of the criteria associated with SDT threshold (S018). The first reference signal received power (RSRP) is measured by the UE when the UE receives the RRC message. The second RSRP is measured by the UE upon initiation of a small data transmission (SDT).

In an embodiment, the SDT threshold may comprise an RSRP difference threshold. The RSRP difference threshold may be UE-specific. The second portion of the criteria associated with SDT threshold comprises a criterion associated with the RSRP difference threshold. The RSRP difference between the first RSRP value and the second RSRP value satisfies the second portion of the criteria associated with SDT threshold when the RSRP difference between the first RSRP value and the second RSRP value satisfies the criterion associated with the RSRP difference threshold. The RSRP difference between the first RSRP value and the second RSRP value does not satisfy the second portion of the criteria associated with SDT threshold when the RSRP difference does not satisfy the criterion associated with the RSRP difference threshold.

In an embodiment, the SDT threshold is commonly shared by configured grant small data transmission (CG-SDT) and RA-SDT.

In an embodiment, the UE performs configured grant small data transmission (CG-SDT) when the first portion of criteria associated with the SDT threshold for RA-SDT is satisfied, and RSRP difference between the first RSRP value and the second RSRP value satisfies the second portion of the criteria associated with SDT threshold.

In an embodiment, the UE starts a timer to time a waiting window upon initiating the CG-SDT and monitors, during the waiting window, a physical downlink control channel (PDCCH) for a response that responds the CG-SDT.

In an embodiment, the base station transmits a dynamic grant assignment for the UE during the waiting window, and the UE receives the dynamic grant assignment for the UE during the waiting window.

In an embodiment, the SDT threshold comprises a synchronization signal block (SSB) level RSRP threshold; and the UE selects a subset of SSBs for small data transmission based on the SSB level RSRP threshold.

In an embodiment, the SSB level RSRP threshold is UE-specific.

In an embodiment, the SSB level RSRP threshold is configured in RRC signalling for a multi-beam operation.

In an embodiment, the SSB level RSRP threshold is commonly shared by CG-SDT and RA-SDT, and the UE selects at least one of available SSBs for CG-SDT based on the SSB level RSRP threshold.

In an embodiment, the SDT threshold comprises a data volume threshold and an RSRP threshold. In an embodiment, the first portion of criteria associated with the SDT threshold for RA-SDT comprises a criterion associated with the data volume threshold and a criterion associated with the RSRP threshold. The first portion of criteria associated with the SDT threshold for RA-SDT is satisfied when the criterion associated with the data volume threshold and the criterion associated with the RSRP threshold are satisfied.

A time alignment validation procedure for small data transmission is proposed in the present disclosure. In one or more embodiments of the present disclosure, the RRC_INACTIVE UE can transmit small data via configured grant small data transmission (CG-SDT), dynamic grant small data transmission (DG-SDT), and or random access small data transmission (RA-SDT), and/or procedure(s) when one or more of the SDT thresholds (e.g., a data volume threshold, RSRP threshold, RSRP difference threshold, and timing/angle difference threshold) is/are met. The SDT thresholds may be configured explicitly or implicitly by RRC singling. Some examples of the SDT thresholds are provided in the following, but are not limited to.
A data volume threshold is used to determine whether the available data volume of UE has reached the data volume threshold so as to allow small data transmission from the UE in RRC_INACTIVE. In CG-SDT, the data volume threshold, if configured, determines the maximum available data volume can be transmitted on the pre-configured resources. In RA-SDT, each of the preamble groups used in random access corresponds to the payload size (i.e., the data volume threshold) in MSGA of 2-step RA-SDT or in MSG3 of 4-step RA-SDT. With reference to FIG. 4, in an embodiment, the base station configures a data volume threshold provided in system information block one (SIB1) to trigger transmission of the uplink small data on the pre-configured SDT resources.
An RSRP threshold is used to determine whether the current RSRP allows the UE to transmit small data in RRC_INACTIVE. The RSRP threshold can be configured at different granularity (e.g., cell-level, beam-level, CG-level, or SSB-level) based on the associated scenario. For example, a cell-level RSRP threshold is applied to the UE within a serving cell of the UE no matter where a location of the UE is. A beam-level RSRP threshold can be used in multi-beam operations. A CG-level RSRP threshold can be used per CG configuration. An SSB-level RSRP threshold is the averaged RSRP of at least one subset of SSBs. The SSB-level RSRP threshold can be used to re-evaluate an SSB for each CG-SDT and can be used per subset of SSBs or all SSBs.
An RSRP difference threshold is used to determine whether an RSRP difference allows the UE to transmit small data in RRC_INACTIVE. The RSRP difference is the difference between two RSRPs measured within two time points. For example, the first time point for measuring one of the two RSRPs is the time when the UE receives the latest time alignment command (TAC) (e.g., upon reception of RRC release message with SDT configuration) from the network. Specifically, RRC release message is RRCRelease, and RRC release message is RRCRelease with suspendConfig, where suspendConfig comprises the SDT configuration. The other time point for measuring one of the two RSRPs is the time when the UE determines to perform SDT (e.g., transmission of UL data that arrives in a TX buffer of the UE) while the TA is not out of date (i.e., TAT is still running). Considering UE's mobility, the UE should calculate the RSRP difference before it performs SDT. When the RSRP difference is less than the RSRP difference threshold and the TA is not out of date (i.e., TAT is still running), the UE is allowed to transmit small data in RRC_INACTIVE. In some cases, when the RSRP difference is not less than the RSRP difference threshold and even the TA is not out of date (i.e., TAT is still running), the UE is not allowed to perform CG-SDT in RRC_INACTIVE. The UE may perform DG-SDT or RA-SDT instead. The RSRP difference threshold may be configured by the network and may be associated with UE's movement scenario (e.g., beam width, and/or across SSBs).
A timing/angle difference threshold is used to determine whether a timing/angle difference measured by the UE allows the UE to transmit small data in RRC_INACTIVE. For example, the timing/angle difference is the timing/angle difference between the last SDT and subsequent SDT. The timing/angle difference may be a measurement of a timing/angle difference between the last time of UL data arriving at a TX buffer of the UE and the latest time of UL data arriving at the TX buffer (e.g., a timing/angle difference between initial SDT and subsequent SDT) during RRC_INACTIVE. In some cases, the timing difference is TDOA, and the angle difference is AOA. The timing/angle difference threshold is associated with UE's movement scenario (e.g., in some scenarios where the UE is moving, timing of received beam of the UE may change, and/or in some scenarios where the UE is moving, timing of selected SSBs of the UE may change). When the timing/angle difference is less than the timing/angle difference threshold and the TA is not out of date (i.e., TAT is still running), the UE is allowed to transmit small data in RRC_INACTIVE. When the timing/angle difference is not less than the timing/angle difference threshold and even the TA is not out of date (i.e., TAT is still running), the UE is not allowed to perform CG-SDT in RRC_INACTIVE. The UE may perform DG-SDT or RA-SDT instead.

In embodiments of the present disclosure, in a CG-SDT procedure, the UE can transmit UL small data on the pre-configured resources without transitioning to RRC_CONNECTED when the configured grant is pre-configured, and the TA is valid. The pre-configured resources are allocated by RRC signaling (e.g., RRCRelease with SuspendConfig). And the pre-configured resources can be common for a set of UE(s) or dedicated for an RRC_INACTIVE UE depending on the addressed 5G NR Radio Network Temporary Identifier (RNTI, e.g., C-RNTI, SDT-RNTI, I-RNTI, CS-RNTI, or P-RNTI) in RRC_INACTIVE state. The network can configure multiple CG configurations (e.g., with different settings of one or more of CG periodicity, SSB-to-PUSCH association, beam width/angle, and others) to the RRC_INACTIVE UE. The pre-configured resources per CG configuration are associated with at least a set of SSBs and/or multiple beams and can be configured by explicit signaling (e.g., RRCRelease). Pre-configured resources for uplink transmission may also be referred to as configured grants (CGs). Each one of CG configurations allocates periodic radio resources each with a configured static size for small data transmission in RRC_INACTIVE. Different CG configurations allocates different configured static sizes for periodic radio resources. When the CG-SDT threshold(s) (e.g., one or more of data volume threshold, RSRP threshold, RSRP difference threshold, timing/angle difference threshold, and others) is met, the UE performs CG-SDT in RRC_INACTIVE. If the UE has subsequent SDT waiting to transmit, some types of feedback information (e.g., one or more of HARQ feedback, SDT buffer status reporting, SDT power headroom reporting, subsequent SDT indication, and others) of the UE can be multiplexed with CG-SDT for performing subsequent CG-SDT. The network transmits a response to respond the feedback information. In some cases, the UE starts a waiting window timed by a timer after CG-SDT and waits for a response from the network during the waiting window timed by the timer. The response may be a DL control signaling (e.g., a dynamic grant) or DL data. If the UE does not receive any response from the network during the waiting window (i.e., the UE does not receive any response from the network before expiration of the timer), the UE may stop monitoring PDCCH for power saving upon expiration of the timer. In an embodiment, the base station transmits a dynamic grant assignment for the UE in the waiting window, and the UE receives the dynamic grant assignment for the UE in the waiting window.

In an embodiment, the UE performs the RA-SDT multiplexed with feedback information for subsequent SDT from the UE. The UE receives a response that responds to the feedback information and performs a subsequent SDT according to the response.

In an embodiment, with reference to FIG. 4, the UE performs the initial CG-SDT multiplexed with feedback information for subsequent SDT from the UE. The UE receives a response that responds to the feedback information and performs a subsequent SDT according to the response.

In an embodiment, the UE performs dynamic grant small data transmission (DG-SDT) after receiving a dynamic grant assignment. For example, the subsequent SDT is random access small data transmission (RA-SDT).

In an embodiment, the feedback information comprises SDT power headroom reporting. In an embodiment, the SDT power headroom reporting is for all activated carrier components.

In an embodiment, the UE transmits an initiating uplink message for random access small data transmission (RA-SDT) to the base station. The base station receives the initiating uplink message, and the initiating uplink message carries at least a portion of uplink small data of the RA-SDT and comprises SDT power headroom reporting.

In an embodiment, the feedback information comprises SDT buffer status reporting. In an embodiment, in the SDT buffer status reporting, SDT-BSR association index of one or more logical channel groups is reported. In an embodiment, the SDT buffer status reporting is performed based on one or more logical channel groups and includes uplink data volume in an uplink transmission buffer of the UE. In an embodiment, logical channel prioritization (LCP) applies for SDT for which the SDT buffer status reporting is performed.

In DG-SDT, the UE can transmit UL small data on the dynamic allocated resources (referred to as dynamic grants (DGs)) without transitioning to RRC_CONNECTED when the dynamic grant is configured to the UE. The dynamic grant is allocated by physical layer signaling (i.e., DG-PUSCH transmissions can be dynamically scheduled by an UL grant via a DCI). The dynamic grant is dedicated to an RRC_INACTIVE UE depending on the feedback information (e.g., one or more of HARQ feedback, SDT buffer status reporting, SDT power headroom reporting, subsequent SDT indication, and others) of the UE. Each dynamic grant is scheduled with a flexible size for small data transmission in RRC_INACTIVE. In some embodiments, the size of a dynamic grant is allocated based on feedback information (e.g., one or more of HARQ feedback, SDT buffer status reporting, SDT power headroom reporting, subsequent SDT indication, and others) of the UE. The allocated resource size of DG may be larger than, smaller than, or equal to the data volume threshold. When determining one or more triggering conditions for triggering dynamic grant allocation for SDT has happened, the network may allocate dynamic resources for the dedicated UE(s). The dynamic grant is scheduled when at least one of the following events is triggered:
The radio resource is available;
SDT retransmission is requested;
Subsequent SDT is requested;
Changing of a serving beam for the UE;
TA may become invalid;
CG resources have been occupied by any of the other UEs; and
Reception of RA-SDT from the UE whereas CG is configured.

When detecting the event indicating that subsequent SDT is requested (e.g., receiving a request for subsequent SDT), the network schedules for the UE a dynamic grant in response to the event. When receiving the dynamic grant in response to the request for subsequent SDT, the UE receives the dynamic grant as a response that replies to the event and performs subsequent SDT through the dynamic grant.

For example, from the network's point of view, when the CG is configured but the RA-SDT is performed by the UE, and if the SDT is multiplexed with BSR/PHR, the network may assume the SDT threshold(s) are not met for the UE to perform CG-SDT. If radio resource(s) is available, the network can schedule dynamic grant for the dedicated UE. From UE's point of view, when the CG-SDT threshold is not met due to some reasons (e.g., a change of serving beam) and even if TA timer (TAT) is running, the UE may perform RA-SDT multiplexed with SDT BSR/PHR to the network. The UE should monitor the response (e.g., one or more of DL data, dynamic grant assignment, and TA command) from the network for subsequent SDT. In some embodiments, when the UE performs CG-SDT multiplexed with an indication showing the request for subsequent SDT to the network, but the UE does not receive any response during the monitoring window/timer due to some reasons (e.g., failure of CG-SDT), the TA may become invalid for subsequent CG-SDT. The UE may perform RA-SDT for small data transmission. The UE determines one or more conditions of SDT failure. In this case, the network can schedule dynamic grant (for the UE) for the subsequent SDT after the RA-SDT. Upon reception of the DG from the network, the UE may perform DG-SDT in response or may recheck SDT threshold(s) (e.g., one or more of RSRP difference threshold and timing/angle difference threshold) to determine which SDT type (i.e., CG-SDT, DG-SDT, or RA-SDT) can be selected to perform. When all the checking are not met for SDT in RRC_INACITVE or the retransmission of SDT has reached the allowed maximum number of times, the UE may perform a non-SDT procedure (i.e., a normal 4-step RA procedure for transiting to RRC_CONNECTED). In some embodiments, the UE starts a waiting window/timer after DG-SDT and waits for a response from the network. If the UE does not receive any response from the network upon the expiration of waiting window/timer, the UE may stop monitoring PDCCH for power saving.

In an RA-SDT procedure, the 2-step RACH and/or 4-step RACH is applied to RACH-based uplink small data transmission in RRC_INACTIVE. The initiating UL message (i.e., CG transmission for CG-SDT, MSGA for 2-step RA-SDT, or MSG3 for 4-step RA-SDT) may contain one or more of common control channel (CCCH) information (e.g., ResumeMAC-I), UL small data, and multiplexed MAC CEs (e.g., SDT BSR, SDT PHR) if needed.

In an embodiment, the UE transmits an initiating uplink message for random access small data transmission (RA-SDT) to the base station. The base station receives the initiating uplink message, and the initiating uplink message carries at least a portion of uplink small data of the RA-SDT and comprises common control channel (CCCH) information. In an embodiment, the UE transmits the initiating uplink message upon expiration of the waiting window. In an embodiment, the initiating uplink message comprises SDT power headroom reporting.

Optionally, transmission of DL data (i.e., CG response for CG-SDT, MSGB for 2-step RA-SDT, or MSG4 for 4-step RA-SDT) and subsequent transmission of UL data (i.e., subsequent SDT) following the initial UL SDT without transitioning to RRC_CONNECTED may be performed if necessary.

The SDT buffer status reporting (BSR) is used to provide the network with information about UL data volume in a UL TX buffer of the UE for subsequent SDT during RRC_INACTIVE when TA is not out of date (i.e., the TAT is still running). In some cases (e.g., one-shot SDT), the transmission of SDT BSR in RRC_INACTIVE is not necessary since the subsequent SDT is not needed. For the subsequent SDT, one or more of the following SDT BSR parameters should be configured:
SDT-periodicBSR-Timer;
SDT-retxBSR-Timer; and
SDT-BSR association index.

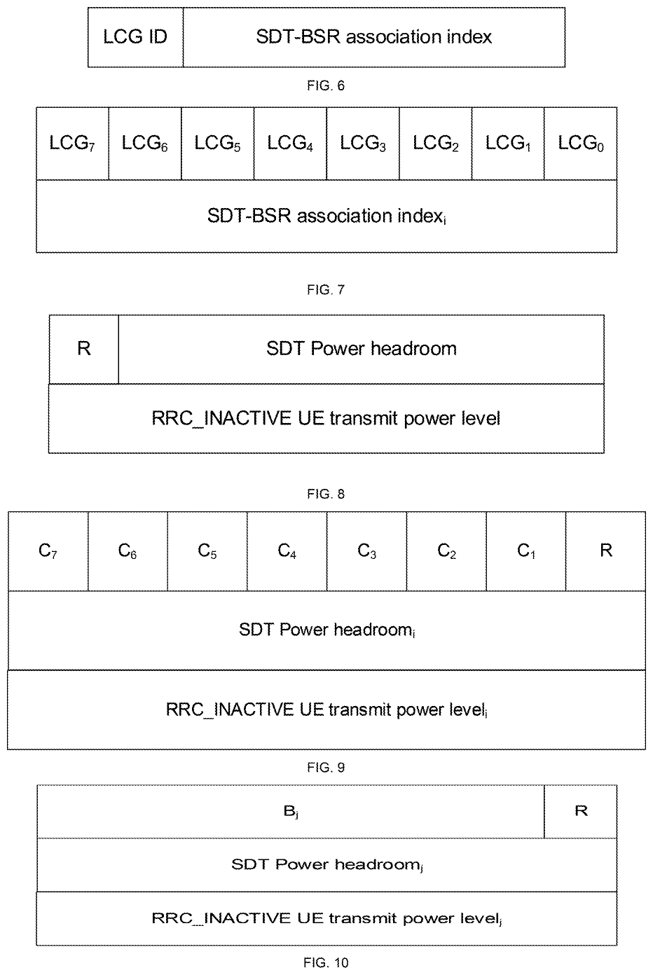

Here, the SDT-periodicBSR-Timer is the timer for periodic reporting of SDT BSR. The SDT-periodicBSR-Timer may be stopped when the SDT is one-shot SDT. The SDT-retxBSR-Timer is the timer for retransmitting SDT BSR. The SDT-BSR association index is the value to indicate the different range of available data volume for SDT. In general, the network may define a mapping table between the index and the range of available data volume for SDT. Upon the reception of SDT BSR, the network may allocate one or more dynamic grants for the UE based on the triggering condition(s). A new LCID or a legacy LCID in a MAC subheader of an SDT BSR MAC CE may be used to identifies a format of the SDT BSR MAC CE. The SDT BSR MAC CE may have a fixed/variable size and comprise one or more SDT-BSR association index field(s) defined as shown in FIG. 6 and FIG. 7.

With reference to FIG. 6 and FIG. 7, the UE can report the UL data volume in a UL TX buffer of the UE in RRC_INACTIVE. In the SDT BSR MAC CE, the UL data volume may be reported by Logical Channel Group (LCG)-based so that the network can determine the priority of the subsequent SDT by the Logical Channel Prioritization (LCP). The SDT BSR MAC CE in FIG. 6 is designed to report the SDT-BSR association index of specific LCG(s), whereas the SDT BSR MAC CE in FIG. 7 is designed to report the SDT-BSR association index of the associated LCGs. The format of the SDT BSR MAC CE comprises one or more of the following fields.
R: Reserved bit(s) for byte alignment (not shown).
LCG ID: The Logical Channel Group ID field identifies the group of logical channel(s) whose available data volume is waiting to be transmitted.
LCG;: The LCG; field indicates the presence of the SDT-BSR association index for the logical channel group i.
SDT-BSR association index: An SDT-BSR association index; in the SDT-BSR association index field indicates the available data volume is waiting to be transmitted on the logical channel group i.

The SDT power headroom reporting (PHR) is used to provide the network with information about the difference between the allowed UE maximum transmit power and the estimated PUSCH transmit power per activated serving cell/beam in RRC_INACTIVE when TA is not out of date (i.e., the TAT is still running). In some cases (e.g., one-shot SDT), the transmission of SDT PHR in RRC_INACTIVE is not necessary since the subsequent SDT is not needed (or not requested). For the subsequent SDT, one or more of the following SDT PHR parameters should be configured:
SDT-phr-PeriodicTimer;
SDT-phr-ProhibitTimer; and
SSB-to-PUSCH association index.

Here, the SDT-phr-PeriodicTimer is the timer for periodic reporting of SDT PHR. The SDT-phr-PeriodicTimer may be stopped when the SDT is one-shot SDT. The SDT-phr-ProhibitTimer is the timer to control the minimum time between two SDT PHRs. Prohibition of SDT PHR which can avoid frequent reporting by the UE may be associated with one or more the measured pathloss variance, measured RSRP difference, and measured timing/angle difference. The SSB-to-PUSCH association index indicates the power headroom difference in associated SSB-to-PUSCH resource mapping. In general, the network may define the SSB-to-PUSCH resource mapping (e.g., time offset and frequency offset associated with a RACH Occasion/CG Period) within the CG configuration. Examples of the resource in an SSB-to-PUSCH resource mapping may comprise a RACH Occasion or a CG Period. The UE may select a proper subset of SSBs based on the SDT threshold configured by the network. A table of power headroom levels for the SSB-to-PUSCH resource mapping may be defined by the network. A table of RRC_INACTIVE UE transmit power level is also defined by the network. The RRC_INACITVE UE reports SDT PHR to the base station that provides a serving cell/beam of the UE for a subsequent UL scheduling decision and link adaptation purposes. When the UE is capable of carrier aggregation (CA), the UE can compute SDT PHR for all activated carrier components (CCs) for group-based power headroom reporting and/or compute SDT PHR for each CC for per-CC based power headroom reporting. Upon the reception of SDT PHR, the network may allocate dynamic grant for the UE based on the triggering condition(s). A new LCID or a legacy LCID in a MAC subheader of an SDT BSR MAC CE may be used to identifies a format of the SDT BSR MAC CE. As shown in FIG. 8 to FIG. 10, the SDT PHR MAC CE may have a fixed/variable size and include one or more fields in the following.
R: Reserved bit(s) for byte alignment if necessary.
Cᵢ: This field indicates the presence of an SDT Power headroom; in an SDT Power headroom field for a carrier component i.
Bⱼ: This field indicates the presence of a SDT Power headroom; in an SDT Power headroom field for a serving beam identifier j.
SDT Power headroom: The SDT power headroom field indicates a power headroom level associated with the defined power headroom table for SSB-to-PUSCH resource mapping. The SDT Power headroom; indicated the power headroom level for the carrier component i. The SDT Power headroom; indicated the power headroom level for the serving beam j.
RRC_INACTIVE UE transmit power level: The RRC_INACTIVE UE transmit power level field indicates the corresponding measured RRC_INACTIVE UE transmit power level associated with the defined table of RRC_INACTIVE UE transmit power level. The RRC_INACTIVE UE transmit power level; indicates the measured RRC_INACTIVE UE transmit power level for the carrier component i. The RRC_INACTIVE UE transmit power level; indicated the measured RRC_INACTIVE UE transmit power level for the serving beam j.

In FIG. 8, the UE can report SDT PHR MAC CE for a single entry in the table representing, an SDT power headroom level and an RRC_INACTIVE UE transmit power level. In FIG. 9, the UE can report SDT PHR MAC CE as per-CC based reporting. In FIG. 10, the UE can report SDT PHR MAC CE for a selected serving beam (Bⱼ). Upon the reception of the SDT PHR, the network may allocate cell-level, CC-level, or SSB beam-level dynamic grant for the UE based on the triggering condition(s).

### EMBODIMENT 1

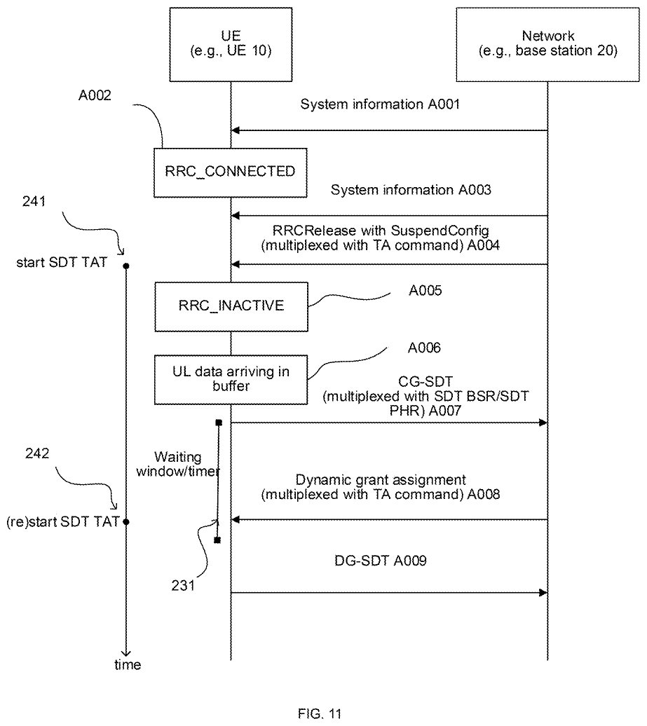

A first embodiment of the present disclosure is as shown in FIG. 11, which depicts implementation scenarios of signal transmission between the UE 10 and the base station 20 according to the present disclosure. For supporting SDT in RRC_INACTIVE, the common/UE-specific SDT configuration, SSB-to-PUSCH resource mapping, SDT threshold(s), and waiting window/timer 231 may be configured in RRC signaling (e.g., system information A001, A003 and/or RRCRelease with SuspendConfig A004). In some cases, the SDT threshold(s) and/or the waiting window/timer 231 can be pre-defined by the network. The SDT time alignment timer (TAT) is started (241) upon reception of the SDT configuration from the network (i.e., an RRC message of RRCRelease with SuspendConfig), and can be (re) started (242) upon the reception of a TA command. After the UE transits from RRC_CONNECTED state (A002) to RRC_INACTIVE state (A005) and UL data arrives in the TX buffer of the UE (A006), if the UL data arriving in the TX buffer is a one-shot SDT (not shown) and the SDT threshold(s) for CG-SDT is met, the UE performs CG-SDT while SDT TAT is running. Upon the expiration of SDT TAT, the UE releases CG resources and keeps CG configuration in RRC_INACTIVE. In an embodiment, the UE starts an SDT time alignment timer (TAT) upon receiving the RRC message, and, upon expiration of the TAT, may release CG resources for CG-SDT. When additional one-shot UL data arrives in the TX buffer of the UE and the SDT threshold(s) for RA-SDT is met, the UE performs RA-SDT while SDT TAT is not running (not shown). It should be noted that the SDT threshold(s) for CG-SDT and RA-SDT can be shared or separated checked, if the SDT criteria of the SDT threshold(s) are not met, the UE performs non-SDT procedure in RRC_CONNECTED (not shown). In some cases, if the UL data arriving in the TX buffer is more than one-shot SDT and SDT TAT is running, when the SDT threshold(s) for CG-SDT is met, the UE performs initial CG-SDT multiplexed with feedback information (e.g., one or more of HARQ feedback, SDT buffer status reporting, SDT power headroom reporting, subsequent SDT indication, and others) of the UE (A007) for performing subsequent CG-SDT (not shown). In some other cases, if the UL data arriving in the TX buffer of the UE is more than one-shot SDT and SDT TAT is running, when the SDT threshold(s) for CG-SDT is met, the UE performs initial CG-SDT multiplexed with feedback information (e.g., one or more of HARQ feedback, SDT buffer status reporting, SDT power headroom reporting, subsequent SDT indication, and others) of the UE for performing subsequent SDT. The UE starts a waiting window/timer 231 after the initial CG-SDT and waits for a response from the network. The response may be a DL control signaling or DL data. For example, when one of the triggering condition(s) (e.g., radio resource(s) is available upon reception of SDT PHR) is met, the network may transmit the dynamic grant assignment for the UE (A008) during the waiting window/timer 231 and may multiplex the dynamic grant assignment with a TA command for restarting the SDT TAT (242). Upon reception of the dynamic grant assignment from the network, the UE may perform DG-SDT in response (A009 in FIG. 11). On the other hand, if the UE does not receive any response from the network upon the expiration of waiting window/timer, the UE may recheck SDT threshold(s) to determine which SDT type (i.e., CG-SDT or RA-SDT) can be selected to perform. When all the checking are not met for SDT in RRC_INACITVE, the UE may perform non-SDT procedure (i.e., normal 4-step RA procedure for transiting to RRC_CONNECTED) (not shown). In some cases, the UE starts a waiting window/timer after DG-SDT and waits for a response from the network. If the UE does not receive any response from the network before expiration of waiting window/timer, the UE may stop monitoring PDCCH (not shown) for power saving.

### EMBODIMENT 2

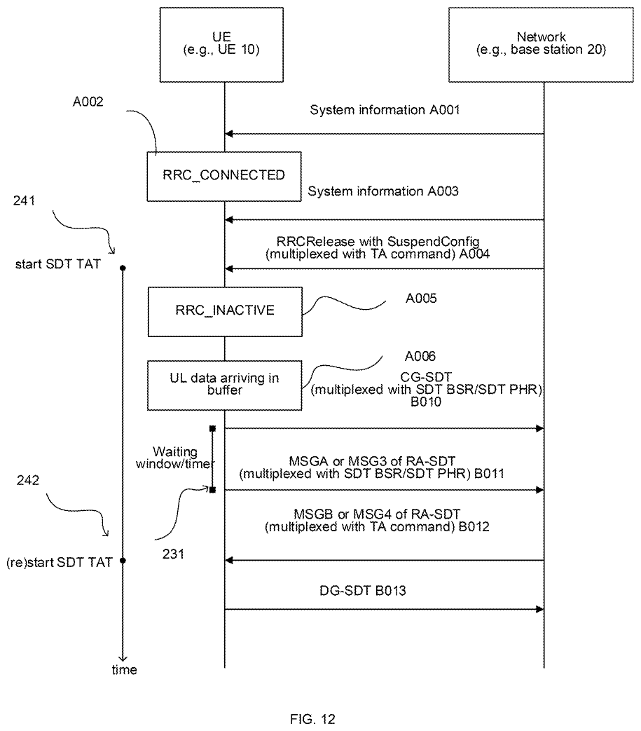

A second embodiment of the present disclosure is as shown in FIG. 12, which depicts implementation scenarios of signal transmission between the UE 10 and the base station 20 according to the present disclosure. For supporting SDT in RRC_INACTIVE, one or more of the common/UE-specific SDT configuration, SSB-to-PUSCH resource mapping, SDT threshold(s), and waiting window/timer 231 may be configured in RRC signaling (e.g., system information A001, A003 and/or RRCRelease with SuspendConfig A004). In some cases, the SDT threshold(s) and/or waiting window/timer can be pre-defined by the network. The SDT time alignment timer (TAT) is started (241) upon reception of the SDT configuration from the network (i.e., RRCRelease with SuspendConfig carries the SDT configuration), and can be (re) started (242) upon reception of a TA command. After the UE transits from RRC_CONNECTED state (A002) to RRC_INACTIVE state (A005) and UL data arrives in the TX buffer of the UE (A006), if the UL data arriving in the TX buffer of the UE is more than one-shot SDT and SDT TAT is running, when the SDT threshold(s) for CG-SDT is met, the UE performs initial CG-SDT multiplexed with feedback information (e.g., one or more of HARQ feedback, SDT buffer status reporting, SDT power headroom reporting, subsequent SDT indication, and others) of the UE (B010) for performing subsequent SDT. The UE starts a waiting window/timer 231 after initial CG-SDT and waits for a response from the network. Upon the expiration of waiting window/timer, if the UE has not received any response from the network, the UE has no idea whether the initial CG-SDT success or not. The UE may perform RA-SDT (B011) for retransmission of data in the initial CG-SDT upon the end of waiting window/timer. The retransmitted data (i.e., a retransmission of data in the initial CG-SDT) may be contained in MSGA of 2-step RA-SDT or in MSG3 of 4-step RA-SDT based on the SDT threshold(s) determination. Furthermore, some types of feedback information (e.g., one or more of HARQ feedback, SDT buffer status reporting, SDT power headroom reporting, subsequent SDT indication, and others) of the UE may be multiplexed with MSGA of 2-step RA-SDT or MSG3 of 4-step RA-SDT to the network. When the triggering condition(s) (e.g., the radio resource is available upon reception of the RA-SDT from the UE whereas CG is configured) is met, the network may transmit the dynamic grant assignment for the UE and may multiplex the dynamic grant assignment with TA command for restarting the SDT TAT (242) in MSGB of 2-step RA-SDT or in MSG4 of 4-step RA-SDT to the UE (B012). Upon reception of the dynamic grant assignment from the network, the UE may perform DG-SDT in response (B013). In this embodiment, a TAT running during movement of the UE may be an incorrect TAT which may cause an invalid TA. If the UE only checks data volume threshold and cell-level RSRP threshold, an invalid TA will result in CG-SDT failure. Checking the RSRP difference threshold or timing/angle difference threshold for TA validation is beneficial in the case that CG-SDT relies upon the correct running TAT.

### EMBODIMENT 3

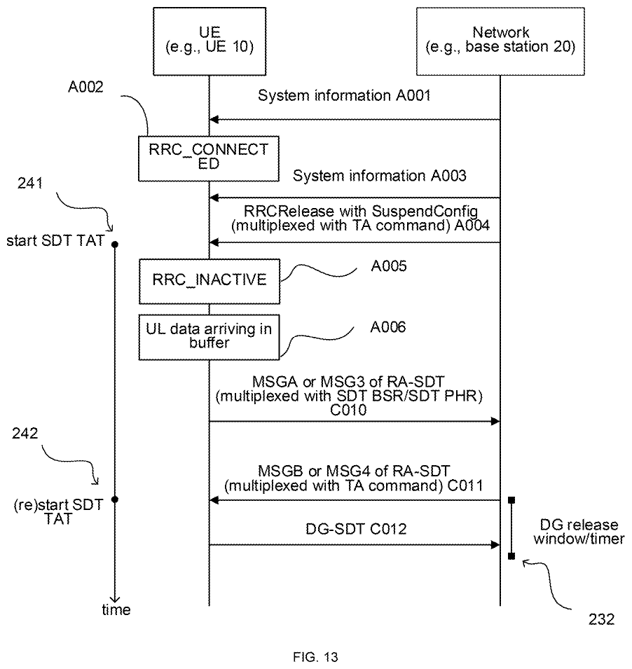

A third embodiment of the present disclosure is as shown in FIG. 13, which depicts implementation scenarios of signal transmission between the UE 10 and the base station 20 according to the present disclosure. For supporting SDT in RRC_INACTIVE, one or more of the common/UE-specific SDT configuration, SSB-to-PUSCH resource mapping, SDT threshold(s), and waiting window/timer 231 may be configured in RRC signaling (e.g., system information A001, A003, and/or RRCRelease with SuspendConfig A004). In some cases, the SDT threshold(s) and/or waiting window/timer can be pre-defined by the network. The SDT time alignment timer (TAT) is started (241) upon reception of the SDT configuration from the network (i.e., RRCRelease with SuspendConfig carries the SDT configuration), and can be (re) started (242) upon reception of a TA command. After the UE transits from RRC_CONNECTED state (A002) to RRC_INACTIVE state (A005) and UL data arrives in the TX buffer of the UE (A006), if the UL data arriving in the TX buffer of the UE is a one-shot SDT (not shown) and the SDT threshold(s) for CG-SDT is not met but the SDT threshold(s) for RA-SDT is met, the UE performs RA-SDT no matter SDT TAT is running (C010). Upon reception of a TA command multiplexed in MSGB of 2-step RA-SDT or in MSG4 of 4-step RA-SDT (C011), the UE restarts the SDT TAT (242). When additional one-shot UL data arrives in the TX buffer of the UE and the SDT threshold(s) for CG-SDT is met, the UE performs CG-SDT while SDT TAT is running (not shown). In some cases, if the UL data arriving in the TX buffer of the UE is more than one-shot SDT and SDT TAT is running, when the SDT threshold(s) for CG-SDT is not met but the SDT threshold(s) for RA-SDT is met, the UE performs initial RA-SDT multiplexed with feedback information (e.g., one or more of HARQ feedback, SDT buffer status reporting, SDT power headroom reporting, subsequent SDT indication, and others) of the UE for performing subsequent SDT. Upon reception of a TA command from the network, the UE rechecks SDT threshold(s) to determine which SDT type (i.e., CG-SDT or RA-SDT) can be selected for subsequent SDT (not shown). In some other cases, if the UL data arriving in the TX buffer of the UE is more than one-shot SDT and SDT TAT is running, when the SDT threshold(s) for CG-SDT is not met but the SDT threshold(s) for RA-SDT is met, the UE performs initial RA-SDT multiplexed with feedback information (e.g., one or more of HARQ feedback, SDT buffer status reporting, SDT power headroom reporting, subsequent SDT indication, and others) of the UE for performing subsequent SDT. When the triggering condition(s) (e.g., the radio resource is available during the occupancy of CG resources by the other UEs) is met, the network may transmit the dynamic grant assignment for the UE and may multiplex the dynamic grant assignment with TA command for restarting the SDT TAT (242) in MSGB of 2-step RA-SDT or in MSG4 of 4-step RA-SDT to the UE. Upon reception of the dynamic grant assignment from the network, the UE may perform DG-SDT in response (C012). On the other hand, for resource efficiency, the network may start a DG release window/timer 232 after transmission of the dynamic grant assignment and wait for the subsequent UL data in the subsequent SDT (e.g., the DG-SDT) from the UE. If the network does not receive any response from the UE upon the expiration of DG release window/timer 232, the network may release DG resource(s).

### EMBODIMENT 4

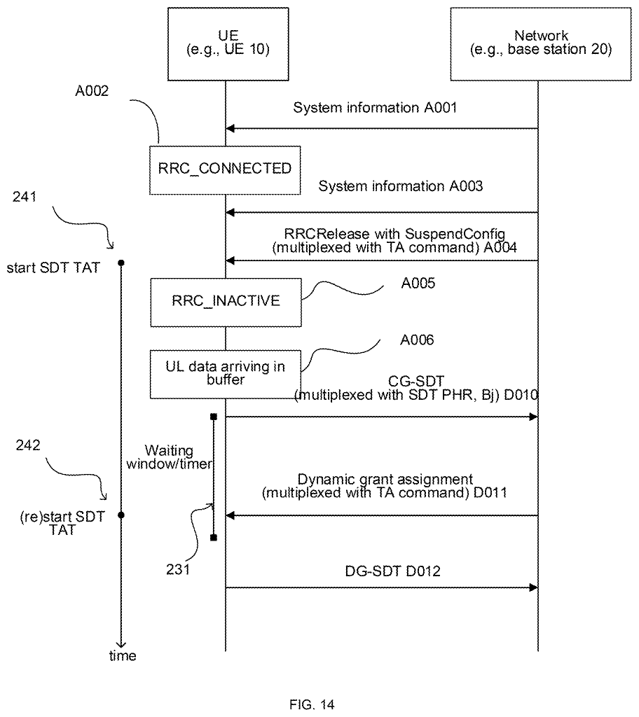

A fourth embodiment of the present disclosure is as shown in FIG. 14, which depicts implementation scenarios of signal transmission between the UE 10 and the base station 20 according to the present disclosure. In multi-beam operations, for supporting SDT in RRC_INACTIVE, one or more of the multi-beam configuration, common/UE-specific SDT configuration, SSB-to-PUSCH resource mapping, SDT threshold(s), and waiting window/timer 231 may be configured in RRC signaling (e.g., system information A001, A003, and/or RRCRelease with SuspendConfig A004). In some cases, the SDT threshold(s) and/or waiting window/timer can be pre-defined by the network. The SDT time alignment timer (TAT) for the SSB serving beam is started (241) upon reception of the SDT configuration from the network (i.e., RRCRelease with SuspendConfig carries the SDT configuration), and can be (re) started (242) upon reception of a TA command. After the UE transits from RRC_CONNECTED state (A002) to RRC_INACTIVE state (A005) and UL data arrives in the TX buffer of the UE (A006), if the UL data arriving in the TX buffer of the UE is a one-shot SDT (not shown) for the SSB serving beam and the SDT threshold(s) for CG-SDT is met, the UE performs CG-SDT (D010) while SDT TAT is running. When additional one-shot UL data arrives in the TX buffer of the UE and the SSB serving beam for the UE changes, the UE checks RSRP difference threshold and/or timing/angle difference threshold for TA validation. If the SDT threshold(s) for CG-SDT is met, the UE performs CG-SDT while SDT TAT is running (not shown).

In some cases, if the UL data arriving in the TX buffer of the UE is more than one-shot SDT and SDT TAT is running, when the SDT threshold(s) for CG-SDT is met, the UE performs initial CG-SDT multiplexed with feedback information (e.g., SDT power headroom reporting for the SSB serving beam) of the UE for performing subsequent CG-SDT (not shown). In some other cases, if the UL data arriving in the TX buffer of the UE is more than one-shot SDT and SDT TAT is running, when the SDT threshold(s) for CG-SDT is met, the UE performs initial CG-SDT multiplexed with feedback information (e.g., SDT power headroom reporting for the SSB serving beam) of the UE for performing subsequent SDT. The UE starts a waiting window/timer 231 after the initial CG-SDT and waits for a response from the network. When the triggering condition(s) (e.g., the radio resource is available upon the change of SSB serving beam) is met, the network may transmit the dynamic grant assignment for the UE (D011) during the waiting window/timer 231 and may multiplex the dynamic grant assignment with TA command for restarting the SDT TAT (242). Upon reception of the dynamic grant assignment from the network, the UE may perform DG-SDT in response (D012). It should be noted that those wider SSB serving beams may be configured with a shorter SDT TAT whereas those narrower SSB serving beams may be configured with a longer SDT TAT. When the UE detects a change of SSB serving beam of UE (e.g., from wider to narrower SSB serving beam), upon the expiation of SDT TAT (e.g., no response from the network), it assumes the CG-SDT will be failure caused by the incorrect running TAT and then transits into RRC_IDLE. When the radio resource is available, the network may schedule DG multiplexed with TA command for restarting the SDT TAT for the UE (242).

### EMBODIMENT 5

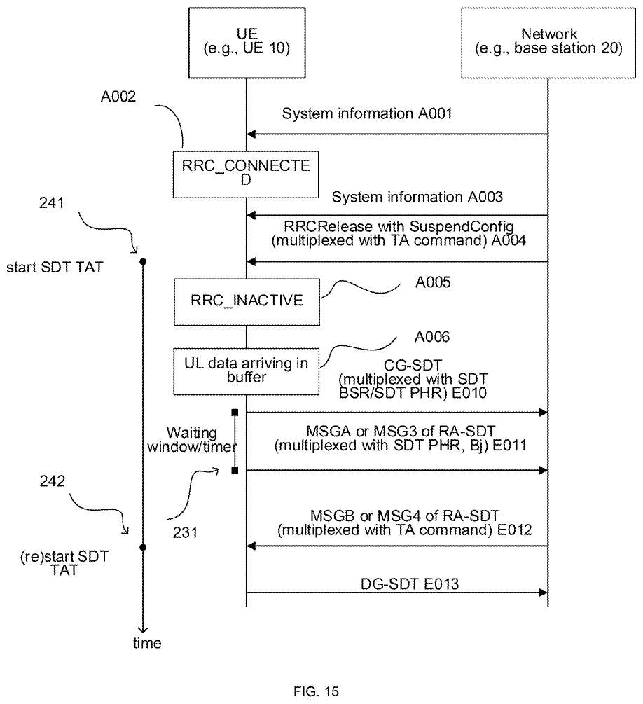

A fifth embodiment of the present disclosure is as shown in FIG. 15, which depicts implementation scenarios of signal transmission between the UE 10 and the base station 20 according to the present disclosure. In multi-beam operations, for supporting SDT in RRC_INACTIVE, one or more of the multi-beam configuration, common/UE-specific SDT configuration, SSB-to-PUSCH resource mapping, SDT threshold(s), and waiting window/timer 231 may be configured in RRC signaling (e.g., system information A001, A003, and/or RRCRelease with SuspendConfig A004). In some cases, the SDT threshold(s) and/or waiting window/timer can be pre-defined by the network. The SDT time alignment timer (TAT) for the SSB serving beam is started (241) upon reception of the SDT configuration from the network (i.e., RRCRelease with SuspendConfig carries the SDT configuration), and can be (re) started (242) upon reception of a TA command. After the UE transits from RRC_CONNECTED state (A002) to RRC_INACTIVE state (A005) and UL data arrives in the TX buffer of the UE (A006), if the UL data arriving in the TX buffer of the UE is more than one-shot SDT and SDT TAT is running, when the SDT threshold(s) for CG-SDT is met, the UE performs initial CG-SDT multiplexed with feedback information (e.g., one or more of HARQ feedback, SDT buffer status reporting, SDT power headroom reporting for the SSB serving beam, subsequent SDT indication, and others) of the UE (E010) for performing subsequent SDT. The UE starts a waiting window/timer 231 after initial CG-SDT and waits for a response from the network. Upon the expiration of waiting window/timer, if the UE has not received any response from the network, the UE may perform RA-SDT for retransmission of data in the initial CG-SDT upon the end of waiting window/timer (E011). The retransmitted data (i.e., a retransmission of data in the initial CG-SDT) may be contained in MSGA of 2-step RA-SDT or in MSG3 of 4-step RA-SDT based on the SDT threshold(s) determination. Furthermore, some types of feedback information (e.g., SDT power headroom reporting for the SSB serving beam) of the UE may be multiplexed with MSGA of 2-step RA-SDT or MSG3 of 4-step RA-SDT to the network. When the triggering condition(s) (e.g., the radio resource is available upon the change of SSB serving beam) is met, the network may transmit the dynamic grant assignment for the UE and may multiplex the dynamic grant assignment with TA command for restarting the SDT TAT (242) in MSGB of 2-step RA-SDT or in MSG4 of 4-step RA-SDT to the UE (E012). Upon reception of the dynamic grant assignment from the network, the UE may perform DG-SDT in response (E013).

### EMBODIMENT 6

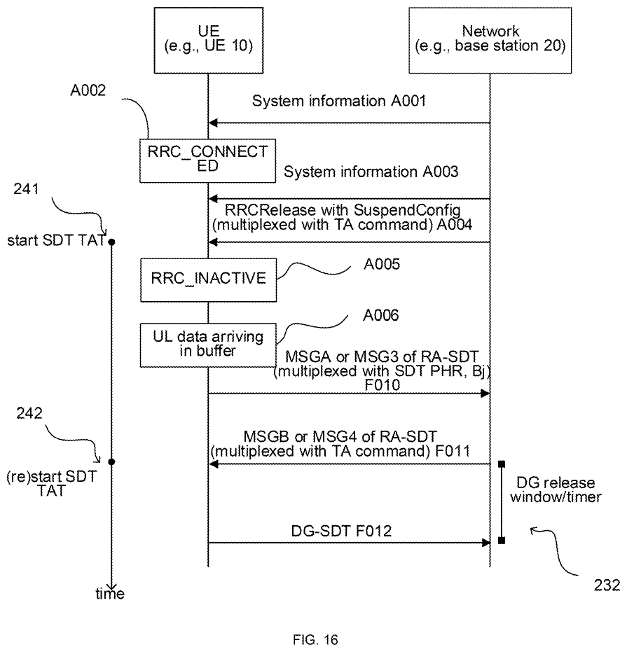

A sixth embodiment of the present disclosure is as shown in FIG. 16, which depicts implementation scenarios of signal transmission between the UE 10 and the base station 20 according to the present disclosure. In multi-beam operations, for supporting SDT in RRC_INACTIVE, one or more of the multi-beam configuration, common/UE-specific SDT configuration, SSB-to-PUSCH resource mapping, SDT threshold(s), and waiting window/timer 231 may be configured in RRC signaling (e.g., system information A001, A003, and/or RRCRelease with SuspendConfig A004). In some cases, the SDT threshold(s) and/or waiting window/timer can be pre-defined by the network. The SDT time alignment timer (TAT) for the SSB serving beam is started (241) upon reception of the SDT configuration from the network (i.e., RRCRelease with SuspendConfig carries the SDT configuration), and can be (re) started (242) upon reception of a TA command. After the UE transits from RRC_CONNECTED state (A002) to RRC_INACTIVE state (A005) and UL data arrives in the TX buffer of the UE (A006), if the UL data arriving in the TX buffer of the UE is a one-shot SDT for the SSB serving beam (not shown) and the SDT threshold(s) for CG-SDT is not met but the SDT threshold(s) for RA-SDT is met, the UE performs RA-SDT (F010) no matter SDT TAT for the SSB serving beam is running. Upon reception of a TA command multiplexed in MSGB of 2-step RA-SDT or in MSG4 of 4-step RA-SDT (F011), the UE restarts the SDT TAT (242). When additional one-shot UL data arrives in the TX buffer of the UE and the SSB serving beam for the UE changes, the UE checks RSRP difference threshold and/or timing/angle difference threshold for TA validation. If the SDT threshold(s) for CG-SDT is met, the UE performs CG-SDT while SDT TAT is running (not shown). In some cases, if the UL data arriving in the TX buffer of the UE is more than one-shot SDT and SDT TAT is running, when the SDT threshold(s) for CG-SDT is not met but the SDT threshold(s) for RA-SDT is met due to the change of SSB serving beam, the UE performs initial RA-SDT multiplexed with feedback information (e.g., SDT power headroom reporting for the SSB serving beam) of the UE (F012) for performing subsequent SDT. When the network receives RA-SDT multiplexed with SDT PHR from the UE whereas CG is configured, if the required resources for the subsequent SDT is smaller than the per CG resource, the network may transmit a TA command for restarting the SDT TAT (242) of the SSB serving beam. The UE rechecks SDT threshold(s) to determine which SDT type (i.e., CG-SDT or RA-SDT) can be selected for subsequent SDT (not shown). In some other cases, if the UL data arriving in the TX buffer of the UE is more than one-shot SDT and SDT TAT is running, when the SDT threshold(s) for CG-SDT is not met but the SDT threshold(s) for RA-SDT is met due to the change of SSB serving beam, the UE performs initial RA-SDT multiplexed with feedback information (e.g., SDT power headroom reporting for the SSB serving beam) of the UE for performing subsequent SDT. When the triggering condition(s) (e.g., the radio resource is available upon the change of SSB serving beam) is met, the network may transmit the dynamic grant assignment for the UE and may multiplex the dynamic grant assignment with a TA command for restarting the SDT TAT (242) in MSGB of 2-step RA-SDT or in MSG4 of 4-step RA-SDT to the UE. Upon reception of the dynamic grant assignment from the network, the UE may perform DG-SDT in response. On the other hand, for resource efficiency, the network may start a DG release window/timer 232 for the SSB serving beam after transmission of the dynamic grant assignment and wait for the subsequent UL data in the subsequent SDT (e.g., the DG-SDT) from the UE. If the network does not receive any response from the associated SSB beam upon the expiration of DG release window/timer 232, the network may release DG resource(s) for the SSB serving beam.

Any schemes, options, and examples in each of the embodiments, either for UE-initiated COT configuration or for harmonization features in NR-U CG or URLLC DG, can be adopted to work together using various combinations for different purposes.

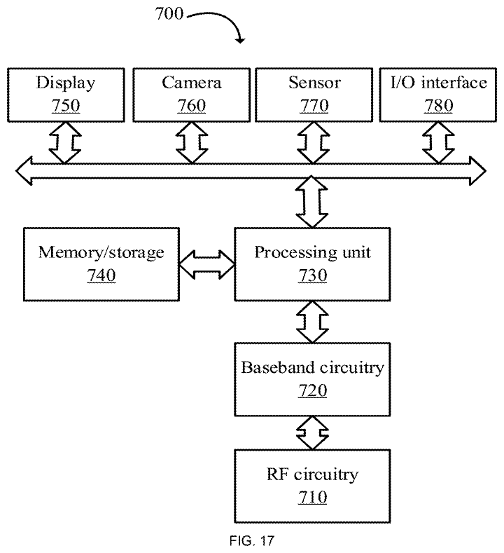

FIG. 17 is a block diagram of an example system 700 for wireless communication according to an embodiment of the present disclosure. Embodiments described herein may be implemented into the system using any suitably configured hardware and/or software. FIG. 17 illustrates the system 700 including a radio frequency (RF) circuitry 710, a baseband circuitry 720, a processing unit 730, a memory/storage 740, a display 750, a camera 760, a sensor 770, and an input/output (I/O) interface 780, coupled with each other as illustrated.

The processing unit 730 may include circuitry, such as, but not limited to, one or more single-core or multi-core processors. The processors may include any combinations of general-purpose processors and dedicated processors, such as graphics processors and application processors. The processors may be coupled with the memory/storage and configured to execute instructions stored in the memory/storage to enable various applications and/or operating systems running on the system.

The baseband circuitry 720 may include circuitry, such as, but not limited to, one or more single-core or multi-core processors. The processors may include a baseband processor. The baseband circuitry may handle various radio control functions that enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with 5G NR, LTE, an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry. In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the UE, eNB, or gNB may be embodied in whole or in part in one or more of the RF circuitries, the baseband circuitry, and/or the processing unit. As used herein, “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the processing unit, and/or the memory/storage may be implemented together on a system on a chip (SOC).

The memory/storage 740 may be used to load and store data and/or instructions, for example, for the system. The memory/storage for one embodiment may include any combination of suitable volatile memory, such as dynamic random access memory (DRAM)), and/or non-volatile memory, such as flash memory. In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite. In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, etc. In various embodiments, the system may have more or less components, and/or different architectures. Where appropriate, the methods described herein may be implemented as a computer program. The computer program may be stored on a storage medium, such as a non-transitory storage medium.

The embodiment of the present disclosure is a combination of techniques/processes that may be adopted in 3GPP specification to create an end product.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of the application and design requirement for a technical plan. A person having ordinary skills in the art may use different ways to realize the function for each specific application while such realizations should not go beyond the scope of the present disclosure. It is understood by a person having ordinary skill in the art that he/she may refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure may be realized in other ways. The above-mentioned embodiments are exemplary only. The division of the units is merely based on logical functions while other divisions exist in realization. It is possible that a plurality of units or components are combined or integrated into another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments may be integrated into one processing unit, physically independent, or integrated into one processing unit with two or more than two units.

If the software function unit is realized and used and sold as a product, it may be stored in a readable storage medium in a computer. Based on this understanding, the technical plan proposed by the present disclosure may be essentially or partially realized as the form of a software product. Or, one part of the technical plan beneficial to the conventional technology may be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A wireless communication method for execution by a user equipment (UE), comprising:
receiving a radio resource control (RRC) message used for transiting the UE to an RRC inactive state;
starting a small data transmission (SDT) time alignment timer (TAT) upon receiving the RRC message;
determining whether timing alignment (TA) for the UE is validated through TA validation at least based on the TAT and at least one measurement of reference signal received power (RSRP) value compared to at least one RSRP associated threshold; and
transmitting uplink (UL) small data on pre-configured SDT resources in the RRC inactive state of the UE when the TA for the UE is validated through TA validation.

2-4. (canceled)

5. The wireless communication method of claim 1, wherein the at least one measurement of RSRP value comprises:
a first RSRP value that is measured by the UE when the UE receives the SDT configuration; and
a second RSRP value that is measured by the UE when the UE determines to perform SDT;
wherein the at least one RSRP associated threshold comprises an RSRP difference threshold;
the TA for the UE is validated through TA validation when an RSRP difference between the first RSRP value and the second RSRP value is less than the RSRP difference threshold; and
the TA for the UE is not valid when the RSRP difference is not less than the RSRP difference threshold.

6. The wireless communication method of claim 5, wherein the RSRP difference threshold that is UE-specific.

7. The wireless communication method of claim 5, wherein the UE performs dynamic grant small data transmission (DG-SDT) when the RSRP difference is not less than the RSRP difference threshold.

8. The wireless communication method of claim 5, wherein the UE performs random access small data transmission (RA-SDT) when the RSRP difference is not less than the RSRP difference threshold.

9. The wireless communication method of claim 8, wherein the UE performs the RA-SDT when the RSRP difference is not less than the RSRP difference threshold while the TAT is running.

10. The wireless communication method of claim 8, wherein the UE determines one or more conditions of SDT failure.

11. The wireless communication method of claim 10, wherein the UE transmits an initiating uplink message for random access small data transmission (RA-SDT), and the initiating uplink message carries at least a portion of uplink small data of the RA-SDT and comprises common control channel (CCCH) information.

12. The wireless communication method of claim 10, wherein upon expiration of the SDT TAT, the UE releases CG resources for CG-SDT.

13. (canceled)

14. The wireless communication method of claim 1, wherein the transmitting uplink small data on the pre-configured SDT resources is an initial configured grant small data transmission (CG-SDT);
the UE starts a timer to time a waiting window after the initial CG-SDT and monitors, during the waiting window, a physical downlink control channel (PDCCH) for a response that responds the initial CG-SDT.

15. The wireless communication method of claim 14, wherein, upon expiration of the waiting window, the UE transmits an initiating uplink message for random access small data transmission (RA-SDT), and the initiating uplink message carries at least a portion of uplink small data of the RA-SDT and comprises common control channel (CCCH) information.

16. The wireless communication method of claim 14, wherein the UE performs the initial CG-SDT multiplexed with feedback information for subsequent SDT from the UE.

17. The wireless communication method of claim 16, wherein the feedback information comprises SDT power headroom reporting.

18-23. (canceled)

24. The wireless communication method of claim 16, wherein the UE receives a dynamic grant assignment for the UE in the waiting window.

25. The wireless communication method of claim 1, wherein the at least one RSRP associated threshold comprises a synchronization signal block (SSB) level RSRP threshold; and
the UE selects a subset of SSBs for small data transmission based on the SSB level RSRP threshold.

26. The wireless communication method of claim 25, wherein the SSB level RSRP threshold is UE-specific.

27-28. (canceled)

29. A user equipment (UE) comprising:
a processor configured to call and run a computer program stored in a memory, to cause a device in which the processor is installed to execute the method of claim 1.

30-33. (canceled)

34. A small data transmission method for execution by a base station, comprising:
configuring an RSRP associated threshold and pre-configured small data transmission (SDT) resources for uplink SDT;
transmitting one or more radio resource control (RRC) messages that carries an SDT configuration including at least one reference signal received power (RSRP) associated threshold for SDT, wherein the RSRP associated threshold comprises an RSRP difference threshold and a synchronization signal block (SSB) level RSRP threshold; and
receiving the uplink SDT.

35. (canceled)

36. The wireless communication method of claim 34, further comprising:
transmitting a time alignment command used for maintaining validation of the pre-configured SDT resources
wherein the UE starts or restarts a small data transmission (SDT) time alignment timer (TAT) upon receiving the time alignment command;
the UE determines whether timing alignment (TA) for the UE is validated through TA validation at least based on the TAT and at least one measurement of reference signal received power (RSRP) value compared to at least one RSRP associated threshold; and
the base station receives uplink (UL) small data on pre-configured SDT resources in the RRC inactive state of the UE when the TA for the UE is validated through TA validation.

37-64. (canceled)

65. A base station comprising:
a processor configured to call and run a computer program stored in a memory, to cause a device in which the processor is installed to execute the method of claim 34.

66-69. (canceled)
